(19) United States
(12) Patent Application Publication
(10) Pub. No.: US 2014/0369851 A1
(43) Pub. Date: Dec. 18, 2014

(54) METHOD OF FABRICATING A SURFACE FOR REDUCING ICE ADHESION STRENGTH

(71) Applicants: Lance Wei Seong Lim, Singapore (SG); Henning Schröder, Hvide Sande (DK); Erwin Merijn Wouterson, Botannia (SG); Shirley Zhang, Rosewood (SG)

(72) Inventors: Lance Wei Seong Lim, Singapore (SG); Henning Schröder, Hvide Sande (DK); Erwin Merijn Wouterson, Botannia (SG); Shirley Zhang, Rosewood (SG)

(73) Assignee: VESTAS WIND SYSTEMS A/S, Aarhus N. (DK)

(21) Appl. No.: 14/345,429

(22) PCT Filed: Sep. 12, 2012
(86) PCT No.: PCT/DK2012/050342

§ 371 Date: Sep. 5, 2014

Related U.S. Application Data
(60) Provisional application No. 61/536,230, filed on Sep. 19, 2011.

(30) Foreign Application Priority Data
Sep. 19, 2011 (DK) PA 2011 70510

(51) Int. Cl. F03D 11/00; B05D 5/02

(52) U.S. Cl. CPC F03D 11/0025; B05D 5/02; F05B 2230/90
USPC 416/241 R; 427/273

(57) ABSTRACT

A method of fabricating a surface for reducing ice adhesion surface which includes providing a surface of a cured material and impacting the surface of the cured material with a pressurized jet of a fluid material to plastically deform the cured material to enable the surface to reduce ice adhesion strength on the surface.

### FIELD OF INVENTION

The present invention relates to a method of fabricating a surface for reducing ice adhesion strength, particularly, fabricating a surface of a wind turbine blade.

### BACKGROUND

During the operation of a surface through cold air, e.g. airfoil of a wind turbine and aircraft wings, it is very likely that ice may be formed on the surface due to freezing of water on the cold surface. The accumulation of ice on the surface can result in undesirable consequences due to the change in the profile of the airfoil caused by the accumulation. For example, on the aircraft wings, a change in the profile reduces the lift-drag ratio of the airfoil which can result in a decrease in the lift or force to lift the aircraft up. This is detrimental to the safety of the aircraft. In another example, in the wind turbine application, the decrease in the lift-drag ratio reduces the speed of rotation of the wind turbine. When this happens, the wind turbine is unable to obtain optimal speed which reduces its efficiency.

There have been many attempts made to prevent ice accumulation on the surfaces as well as attempts made to remove the ice that has accumulated on the surfaces. In the former, material which prevents adhesion of substance e.g. Teflon® coating is applied onto an underlying painted surface so that ice can slip off the coating and is prevented from accumulating on the surface. However, the application of the coatings can be costly and repeat applications of the coatings to replace worn out coatings would increase cost and downtime of the machines. In the latter, deicing fluid or micro-vibration has been used to dislodge the ice from the surface. Similarly, the addition of pumps for the application of deicing fluid or vibration inducing components increases cost and would require constant maintenance of the additional parts.

The present invention aims to provide a surface for reducing ice adhesion strength without the disadvantages discussed above.

### SUMMARY OF THE INVENTION

According to the present invention, a method of fabricating a surface for reducing ice adhesion strength as defined in claim 1 is provided. A wind turbine according to the present invention is defined in claim 16. A use of the method according to the present invention for providing a wind turbine blade with a surface for reducing ice adhesion strength is defined in claim 17. The dependent claims show some example of such a method or wind turbine or use, respectively.

The invention provides a method of fabricating a surface for reducing ice adhesion strength which includes providing a surface of a cured material and impacting the surface of the cured material with a pressurized jet of a fluid material. This may be performed such that the surface is thereby subjected to plastic deformation due to the force imparted by the fluid material. In this way, the plastic deformation creates the specific morphology for reducing ice adhesion strength surface to achieve the desired properties without additional layers or components.

Preferably, the fluid material upon impact is deflected and/or removed from the surface so that the fluid material does not remain on the surface.

Preferably, the method includes applying a coating of the curable material onto a substrate where the coating of curable material has a surface; and curing the coating of curable material.

Preferably, the cured material is visco-elastic and is capable of being deformed plastically.

Preferably, the fluid material use is one of air, a liquid, a liquid mixed with solid particles and solid particles.

Preferably, the fluid material used is dry ice pellets as it is effective and do not contaminate the coating or leave any contaminant on the coating.

The present invention further provides a wind turbine comprising a plurality of blades having a surface for reducing ice adhesion strength fabricated by the method described above.

The present invention further provides a use of the method as described above for providing a wind turbine blade with a surface for reducing ice adhesion strength.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various embodiments of the invention are described with reference to the following drawings, in which:

FIG. 1 shows a common setup of a wind turbine.

FIG. 2 shows an exemplary embodiment of the present invention produced by an exemplary method according to the present invention;

FIG. 3 shows a substrate of the embodiment of FIG. 2;

FIG. 4 shows an application of a coating on the substrate in FIG. 3;

FIG. 5 shows an impacting step of the coating in FIG. 4;

FIG. 6 shows an exemplary apparatus for injecting a pressurized jet for the impacting step in FIG. 5;

FIG. 7 shows a frontal view of the sprayer of the apparatus in FIG. 6;

FIG. 8 shows a representation of a section of a surface after impacting step in FIG. 5; and

### DESCRIPTION

The following detailed description refers to the accompanying drawings that show, by way of illustration, specific details and embodiments in which the invention may be practiced. These embodiments are described in sufficient detail to enable those skilled in the art to practice the invention. Other embodiments may be utilized and structural, logical, and electrical changes may be made without departing from the scope of the invention. The various embodiments are not necessarily mutually exclusive, as some embodiments can be combined with one or more other embodiments to form new embodiments.

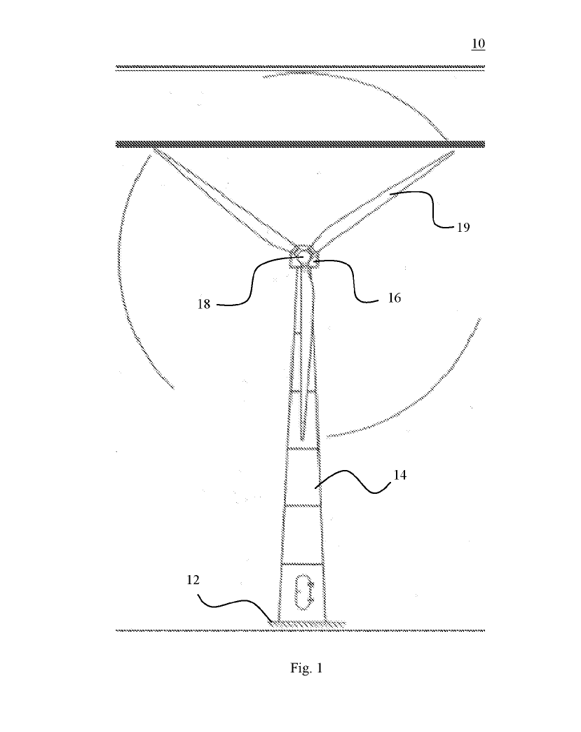

FIG. 1 shows a common setup of a wind turbine 10 in which embodiments may be used. The wind turbine 10 is mounted on a base 12. The wind turbine 10 includes a tower 14 having a number of tower sections. A wind turbine nacelle 16 is placed on top of the tower 14. The wind turbine rotor includes a hub 18 and at least one rotor blade or wind turbine blade 19, e.g. three wind turbine blades 19. The wind turbine blades 19 are connected to the hub 18 which in turn is connected to the nacelle 16 through a low speed shaft which extends out of the front of the nacelle 16.

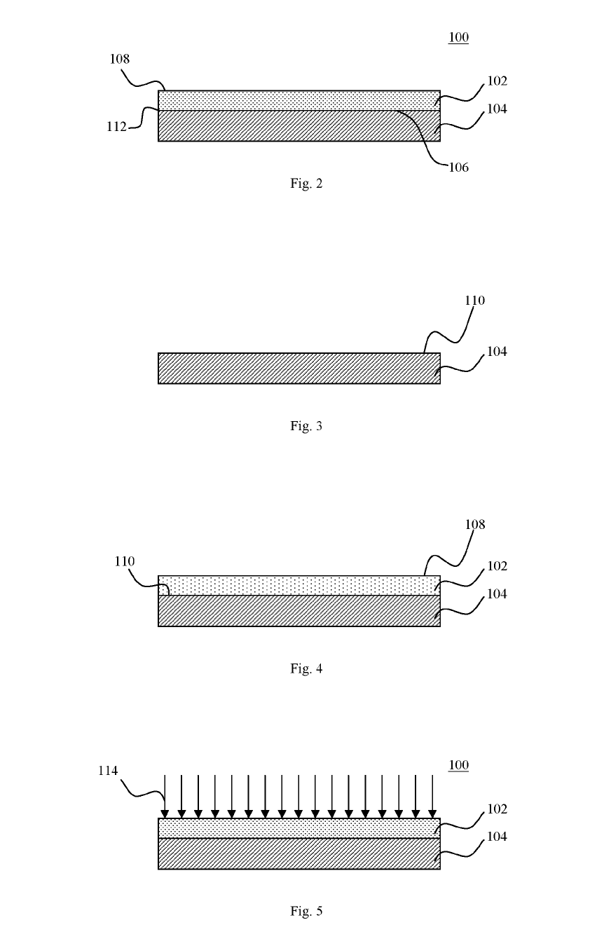

FIG. 2 shows an exemplary embodiment 100 having a coating 102 on a substrate 104. The coating 102 has an interfacing surface 106 and a surface 108 for reducing ice adhesion strength. The interfacing surface 106 meets the substrate 104 at an interface 112 and the surface 108 faces away from the substrate 104. A method of fabricating the surface 108 is described hereinafter.

The method of fabricating the surface 108 is shown in FIGS. 3 to 4. In FIG. 3, a substrate 104 is provided. The substrate 104 can be part of an airfoil of a wind turbine blade 19 in FIG. 1, an aircraft wing, or any surface that requires ice adhesion resistance property that the method is applicable to. The substrate 104 can be made from a material that is conventionally used for the respective purposes mentioned. For example, the substrate 104 can be made form a fiberglass/epoxy substrate with a layer of gelcoat applied onto the substrate (not shown in FIG. 3).

As shown in FIG. 3, substrate 104 has a surface 110. The surface 110 may be treated (e.g. sanding) or cleaned by conventional methods before applying the coating 102.

In FIG. 4, the coating 102 is applied onto the surface 110. The coating 102 may be a fluid based e.g. paint, or layered etc. The method of application of the coating 102 can be dependent on the type of coating used. For fluid based coating, the coating 102 may be sprayed onto the surface 110. One of the methods of spraying is by using an airless spray apparatus as it is more effective than conventional compressed air spray. For layered coatings, adhesive layered coating may be applied to the surface 110. The adhesive layered coating may be self adhesive. Additionally, heat may be applied to melt the coating onto the surface 110. However, other methods of applying the coating 102 are possible and can be contemplated. The environment in which the coating 102 is being applied is dependent on the type of methods used. For example, the application of coating 102 may be carried out at a relative humidity level in the range of 10% to 70% at a temperature range of 18° C. to 26° C. For example, the relative humidity may be in the range of 20% to 60%. In another example, the relative humidity may be in the range of 30% to 50%. In yet another example, the relative humidity may be in the range of 35% to 45%. For example, the temperature range is 20° C. to 25° C. In another example, the temperature range is 18° C. to 21° C. The coating 102 can be made of a curable material that can be cured on the surface 110. The curable material may be a curable plastic material. Although, the coating 102 may contain polyurethane e.g. polyurethane based paint, other types of compound e.g. polychromatic or metallic paint may be used. Alternatively, the coating 102 may include a layer of polyurethane. Preferably, the cured material is visco-elastic and is capable of being deformed plastically.

After the application of coating 102 onto surface 110, the coating 102 may be cured. To cure the coating 102, the substrate 104 together with the coating 102 is placed into a climate chamber for curing at a controlled humidity and temperature. Preferably, the curing of the coating 102 is carried out in the climate chamber with a relative humidity in the range of 10% to 70% and a temperature range of 18° C. to 26° C. for a time period in the range of 4 to 6 hours. For example, the relative humidity may be in the range of 65% to 68%. In another example, the relative humidity may be in the range of 66% to 69%. For example, the temperature range is 18° C. to 25° C. In another example, the temperature range is 20° C. to 23° C. For example, the time period is in the range of 4½ to 5 hours.

Curing is a process which hardens, dries or stabilizes a coating sufficiently so that the coating is suitable to be treated subsequently. Although a specific environment is described for the curing of the coating 102 above, other methods and parameters of curing can be used depending on the coating used. For example, conduction, convention, radiation of coating; at room temperature and pressure or elevated or reduced temperature; at a required relative humidity etc. The cured material is preferably visco-elastic and is capable of being deformed plastically. Preferably, the cured material is a plastic material. Preferably, the cured material comprises polyurethane or a layer of polyurethane.

FIG. 5 shows the coating 102 being impacted by a pressurized jet of a fluid material 114 denoted by the arrows. Although a coating 102 is prepared for impacting of a pressurized jet of fluid material 114 as shown above, the impacting can be performed to achieve the effect of reducing ice adhesion strength on a surface as long as a surface of cured material is provided. The fluid material 114 may be air, a liquid e.g. water, water and acid; a liquid mixed with solid particles e.g. water and polymer particles (preferably of a nature such that the particles ricochet or deflected from the coating 102 and not embedded into the coating 102), water and walnuts, water and sand; and solid particles e.g. glass, metal (shot peening), sand (sandblasting). In an example, the jet has an average diameter of 1-5 mm. In another example, the jet has an average diameter of 1-2 mm. Preferably, the pressurized jet may be at a pressure in the range from 1000 psi to 8000 psi (6.895 MPa to 55.158 MPa). For example, the pressure is in the range from 1500 psi to 7500 psi (10.342 MPa to 51.711 MPa). In another example, the pressure is in the range from 2000 psi to 7000 psi (13.790 MPa to 48.263 MPa). The impacting may be carried out for a duration of 4 minutes or less. For example, 3 minutes or less. In another example, 2 minutes or less. The pressure and duration of impact can be varied as required. If the pressure of the impact is increased, the duration of the impact may be reduced. However, it is found that a pressurized jet of approximately 8000 psi (55.158 MPa) or higher may damage the coating 102 as the coating 102 may be blown off the substrate 104. The fluid material 114 impacting the surface 108 may be at room temperature. Alternatively, the fluid material may be at higher temperatures, e.g. 25° C. to 60° C., as it can ‘soften’ the coating 102 which enhances plastic deformation of the coating 102. For example, 30° C. to 55° C. In another example, 35° C. to 50° C. In any case, the temperature of the pressurized jet of fluid material 114 should preferably be below a glass transition temperature of the coating 102. Preferably, the temperature of the pressurized jet of fluid material 114 should be close to the glass transition temperature. For example, the glass transition temperature of a polyurethane layer is about 65° C. The coating 102 may be heat treated to elevate its temperature. The pressurized jet may preferably be pulsating but a continuous jet may be used. Prior to the impacting of surface 108, there is no specific pre-treatment required for the impacting once the coating 102 has been applied and cured.

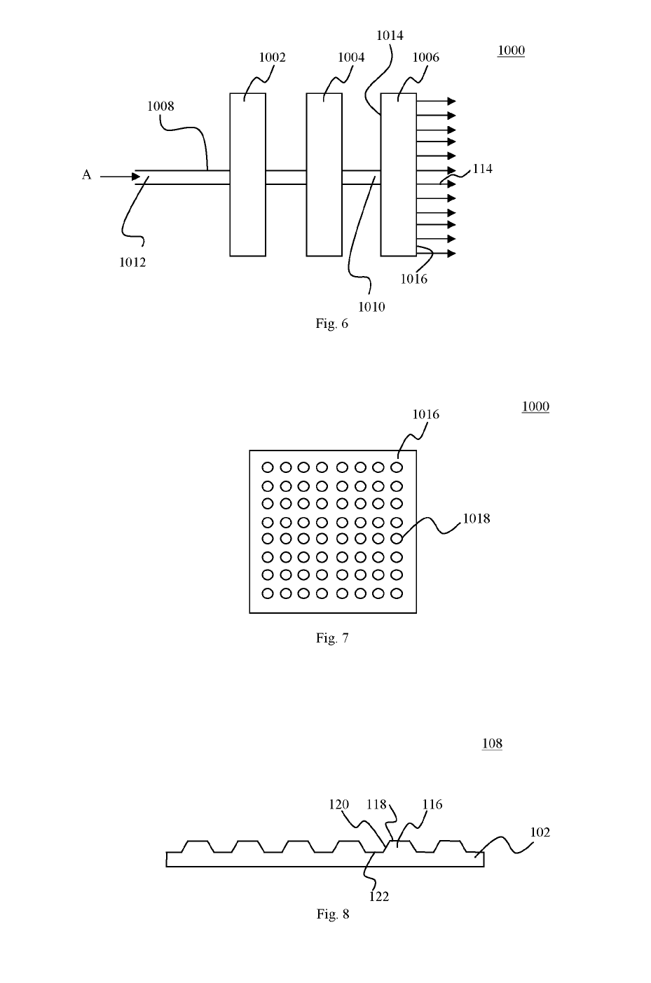

An exemplary apparatus 1000 for injecting the pressurized jet is shown in FIG. 6. The apparatus in FIG. 6 can be used for injecting most fluid materials as described above. However, dry ice may not be applicable if the temperature of the fluid material is elevated close to the glass transition temperature of the surface 108 as the dry ice would have sublimed at that temperature. The apparatus 1000 may have a pressurizer 1002, a heater 1004 and sprayer 1006. In this example, the heater 1004 can be arranged to be between the pressurizer 1002 and the sprayer 1006. However, pressurizer 1002 may also be arranged between the heater 1004 and the sprayer 1006. A fluid material supply conduit 1008, in fluid communication with the sprayer 1006, has a first end 1010 and a second 1012 such that the first end 1010 may be connected to the sprayer 1006 and the second end 1012 may be connected to a pressurized fluid material source (not shown in FIG. 6). An arrow, A, denotes the direction of fluid material supplied into the supply conduit 1008. The size and shape of the pressurizer 1002 and heater 1004 can be selected by a person skilled in the art based on the variables of the pressurized jet.

FIG. 7 shows an elevation view of the sprayer 1006. The sprayer 1006 has a connection side 1014 and a nozzle side 1016. The nozzle side 1016 has a plurality of nozzles 1018 which are in fluid communication with the supply conduit 1012. In the example in FIG. 7, the nozzles 1018 are arranged in a grid-like configuration. For example, a 8 by 8 configuration. However, the nozzles 1018 may be arranged in any configuration which is suitable for the spraying of the pressurized jet of fluid material 114 onto the surface 108 e.g. circular configuration, triangular configuration. The diameter of the nozzles 1018 can be in the range of 2 mm to 10 mm. Depending on the requirements of the fluid material 114, the diameter of nozzles 1018 can be 3 mm to 8 mm, 4 mm to 6 mm etc. The nozzles 1018 may be protruded from or flushed with the nozzle side 1016.

Apart from the fluid material 114 as mentioned above, the fluid material 114 may consist of dry ice pellets. The pellets may have a size approximately in the range from 2 mm to 10 mm. The advantage of using dry ice pellets is that it does not contaminate the coating 102 and do not leave any contaminant on the coating 102 unlike solid particles like sand or any other particles that may be embedded in coating 102 which is ductile e.g. polyurethane. This is due to the fact that the dry ice pellets sublime and return to the atmosphere as carbon dioxide (CO₂) gas.

From the impact of the pressurized jet of fluid material 114, the coating 102 undergoes plastic deformation due to the force imparted by the fluid material 114. In this way, the plastic deformation creates the specific morphology suitable for reducing the ice adhesion strength on a surface.

FIG. 8 shows a schematic representation of a section of the surface 108 after impacting. The representation shows a plurality of protrusions 116, each having a top edge 118 and side walls 120. The surface 108, having undergone plastic deformation after impacting, can be substantially undulating. The representation is used to facilitate the explanation of morphology suitable for reducing the ice adhesion strength on the surface 108. The top edges 118 forms a top plane. Between each protrusion 116 is a base 122. The bases 122 form a bottom plane. The wall 120 is formed between the top plane and base plane and the angle between the wall and the base plane is of an obtuse angle i.e. greater than 90°, for example 90° to 135°, 95° to 120°, 100° to 110°. In another words, the walls adjacent each base 122 forms a V-shape configuration such that ice which is adhered to the surface 108 can be dislodged more easily thus improving the effect of reducing ice adhesion strength on the surface 108.

It can be seen from the above that the method can be used on a wind turbine blade having a protective coat, e.g. polyurethane paint. By applying the method, it is possible to obtain ice adhesion resistant property without the need for an additional layer of icephobic coating. Without having to add a layer of icephobic material, the production time of and resources for the blades are reduced. This would translate to cost savings and yet achieve the desired property. Without additional layers, there is also no need for replacement of any worn out icephobic coatings which translates to further cost savings.

Additionally, the method can be portable as the apparatus for impacting the protective coat can be small enough to be transported to the required location. As such, the method may be applied to existing installations e.g. wind turbine blades and airplane wings, without having to remove the installations to be coated with an icephobic coating and maybe cured in an enclosure. In this way, unnecessary downtime and cost are avoided.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

What is claimed is:

1. A method of fabricating a surface for reducing ice adhesion strength comprising:
providing a surface of a cured material; and
impacting the surface of the cured material with a pressurized jet of a fluid material.

2. The method according to claim 1 wherein providing comprises:
applying a coating of a curable material onto a substrate, the coating of curable material having a surface; and
curing the coating of curable material.

3. The method according to claim 1 wherein the pressurized jet has a pressure in the range from 1000 psi to 8000 psi (6.895 MPa to 55.158 MPa).

4. The method according to claim 1 wherein the cured material is visco-elastic and is capable of being deformed plastically.

5. The method according to claim 1 wherein the cured material is a plastic material and/or wherein the cured material comprises polyurethane or a layer of polyurethane.

6. The method according to claim 1 wherein the fluid material comprises one of air; a liquid; a liquid mixed with solid particles; and solid particles.

7. The method according to claim 1 wherein the temperature of the pressurized jet of fluid material is in the range of 25° C. to 60° C.

8. The method according to claim 1 wherein the fluid material comprises dry ice pellets.

9. The method according to claim 1 wherein the pressurized jet is pulsating or continuous.

10. The method according to claim 1 wherein impacting is carried out for a duration of 4 minutes or less.

11. The method according to claim 1 wherein the cured material has a glass transition temperature and the temperature of the pressurized jet of fluid material is below the glass transition temperature of the cured material.

12. The method according to claim 11 wherein the glass transition temperature is about 65° C.

13. The method according to claim 2 wherein applying the coating is carried out at a relative humidity level in the range of 10% to 70% and at a temperature range of 18° C. to 26° C.

14. The method according to claim 2 wherein applying the coating includes spraying of the coating onto the substrate.

15. The method according to claim 2 wherein curing the coating is carried out in a climate chamber having relative humidity in the range of 65% to 70% and a temperature range of 18° C. to 26° C. and for a period in the range of 4 to 6 hours.

16. A wind turbine comprising a plurality of blades having a surface for reducing ice adhesion strength fabricated by the method as claimed in claim 1.

17. (canceled)

18. A method of fabricating a surface for reducing ice adhesion strength comprising:
providing a surface of a cured material, the providing comprising:
applying a coating of a curable material onto a substrate, the coating of curable material having a surface and the cured material having a glass transition temperature; and
curing the coating of curable material; and
impacting the surface of the cured material with a pressurized jet of a fluid material, wherein a temperature of the pressurized jet of fluid material is below the glass transition temperature of the cured material.

19. The method according to claim 18 wherein the pressurized jet has a pressure in the range from 1000 psi to 8000 psi (6.895 MPa to 55.158 MPa).

20. The method according to claim 18 wherein the cured material comprises at least one of: a plastic material and polyurethane.

21. The method according to claim 18 wherein the fluid material comprises dry ice pellets.
